(19) United States
(12) Patent Application Publication
(10) Pub. No.: US 2021/0112736 A1
(43) Pub. Date: Apr. 22, 2021

(54) ELECTROMECHANICAL DRIP IRRIGATION DEVICE

(71) Applicants: Hadi Adbulameer Al-Agele, Corvallis, OR (US); Chad W. Higgins, Corvallis, OR (US)

(72) Inventors: Hadi Adbulameer Al-Agele, Corvallis, OR (US); Chad W. Higgins, Corvallis, OR (US)

(73) Assignee: Oregon State University, Corvallis, OR (US)

(21) Appl. No.: 17/073,814

(22) Filed: Oct. 19, 2020

Related U.S. Application Data
(60) Provisional application No. 62/924,284, filed on Oct. 22, 2019.

(51) Int. Cl. A01G 25/02; A01G 25/16

(52) U.S. Cl. CPC A01G 25/02; A01G 2025/006; A01G 25/167; A01G 25/165

(57) ABSTRACT

Disclosed herein are embodiments of a device that is useful for drip irrigation. The device comprises a drip line connection unit, a valve and a measurement unit that counts water drops. And the device may further comprise a control unit. The device attached to a drip irrigation line and produces water drops of a known size, counts the number of drops to determine the volume of water being applied, and shuts off the water flow once a desired amount of water has been provided.

### CROSS REFERENCE TO RELATED APPLICATION

This application claims the benefit of the earlier filing date of U.S. provisional patent application No. 62/924,284, filed Oct. 22, 2019, which is incorporated herein by reference in its entirety.

### FIELD

The disclosed technology concerns a device for controlling the amount of water applied in a drip irrigation system.

### BACKGROUND

Drip irrigation has proliferated as an irrigation technology in recent decades. Drip accounted for about 5% of irrigation systems in the US in 1988. By 2010, drip accounted for about 40% of irrigated land in California. Drip irrigation has high efficiency and reduces water losses. Studies on the effects of drip irrigation with respect to water use efficiency, plant growth, yield and quality found significant increases in water use efficiency, plant growth (number of leaves, leaf area, plant height, and matter production) and crop quality compared with flood irrigation, as well as reduced agronomic costs for weed control, fertilization, and tillage.

One of the principle concerns for field scale drip irrigation is the potential for nonuniform water application as a result of pressure changes within the drip line. Pressure changes result from energy losses within the drip line or elevation changes from uneven ground. Currently, pressure compensated emitters (with a design flow rate) are operated for a set period of time to try to address this issue. But this approach leaves no possibility to verify the applied amount of water being applied, or vary the water application at different sites along the line.

Variable-rate irrigation (VRI) can increase irrigation efficiency through targeted, site-specific water application. VRI is widely available for overhead sprinkler irrigation systems, but there are no variable rate drip irrigation (VRDI) systems in the current marketplace. To enable full VRDI, each drip emitter inlet and/or outlet must be individually outfitted with a flow meter to obtain flow data, a communication unit to relay that data to a microprocessor or a decision maker, a controller which can act on that signal, and a valve or other flow control device that can initiate or terminate flow. Recent advances in data telemetry, miniaturized valves and electronic controllers have made flow control possible at the emitter and field scale. Inexpensive flow measurement at the individual emitter is the remaining obstacle that must be overcome to enable VRDI.

### SUMMARY

Disclosed herein are embodiments of a device for drip irrigation that enables a drip irrigation system to deliver a precise amount of water at each drip location in the system, irrespective of water pressure variations long a drip line. The device counts water drops of a known and/or selected size, and stops water flow once a desired number of drops, and therefore a desired volume, has been applied. In some embodiments, the device comprises a drip line connection unit, a valve fluidly connected to the drip line connection unit, and a measurement unit fluidly connected to the valve. The drip line connection unit may comprise a connector component and a lid component that together attach to an irrigation drip line, thereby fluidly connecting the drip line connection unit to the drip line. And/or the drip line connection unit may further comprise a blade or needle that perforates an irrigation drip line to facilitate water flow into the disclosed device. And in some embodiments, the drip line connection unit further comprises a tortuous path.

The measurement unit may comprise a nozzle configured to form water drops and is configured to count water drops formed by the nozzle. The nozzle may have an outer diameter of from 1 mm to 5 mm, such as from 3 mm to 3.5 mm, and/or have an inner diameter of from 0.5 mm to 3 mm. And in some embodiments, the measurement unit comprises two leads that define an air gap. The air gap may be selected such that there is no physical or electrical contact between the two leads until a water drop falls into the air gap, thereby forming an electrical connection between the two leads.

The valve may be any suitable valve that can allow and stop water flow. The valve may be an electrical valve and may be a valve that can be controlled be an electrical signal. In some embodiments, the valve is an electrical solenoid valve. The disclosed device may further comprise a control unit. The control unit may be configured to close the valve when the required number of water drops have passed through the measurement unit.

In particular embodiments, the device comprises a drip line connection unit comprising a tortuous path and a blade or needle that perforates an irrigation drip line, an electronic solenoid valve fluidly connected to the drip line connection unit, a measurement unit fluidly connected to the valve, the measurement unit comprising a nozzle having an outer diameter of from 3 mm to 3.5 mm and two leads that together define a gap having a size sufficient that when a water drop formed by the nozzle passes through the gap the water drop forms an electrical contact between the two leads, and a control unit electronically connected to the two leads and the electronic solenoid valve, the control unit configured to close the electronic solenoid valve when a desired number of drops have been counted.

Also disclosed herein is a method of using the device. The method may comprise providing the disclosed device and using the device. Using the device may comprise setting a number of water drops to be applied. Additionally, or alternatively, the method may further comprise attaching the device to a drip line.

The foregoing and other objects, features, and advantages of the invention will become more apparent from the following detailed description, which proceeds with reference to the accompanying figures.

### BRIEF DESCRIPTION OF THE DRAWINGS

FIG. 1 is a digital image of an exemplary embodiment of the disclosed technology.

FIG. 2 is a digital image illustrating the progression of a water drop from formation to emission from a 3.5 mm nozzle and demonstrating how the water drop completes the electrical circuit between the two wires.

FIG. 3 is a graph of water flow versus pressure, illustrating the relationship between water flow and pressure both with normal drip irrigation and the disclosed VRDI emitter design using a 3 mm and a 3.5 mm nozzle.

FIG. 4 is a graph of drop volume versus pressure, illustrating the relationship between water drop volume and water pressure with embodiments of the disclosed VRDI technology.

FIG. 5 provides digital images illustrating the exemplary Adafruit feather microcontroller board (M0) and relay.

FIG. 6 provides a digital image of the drip line connection unit of the device, illustrating how the connector component and the lid component together form the drip line connection unit around a drip line.

FIG. 7 is a schematic diagram illustrating the connector component of an exemplary embodiment of the drip line connection unit, comprising a screw thread connection.

FIG. 8 is a schematic diagram illustrating the lid component of the exemplary embodiment of the drip line connection unit, that together with the connector component shown in FIG. 7 forms the drip line connection unit.

FIG. 9 is a schematic diagram illustrating a side view of the component of the drip line connection unit shown in FIG. 7.

FIG. 10 is a digital image illustrating how the drip line connection unit can be located on a drip line by separating the two components of the unit.

FIG. 11 is a digital image illustrating a perforation in the drip line that can be formed and/or covered by the drip line connection unit of the disclosed device.

FIG. 12 is a digital image of the connector component of an exemplary embodiment of the drip line connection unit, illustrating the tortuous path.

FIG. 13 is a digital image of the connector component of the drip line connection unit of FIG. 12, illustrating the inlet of the tortuous path.

FIG. 14 is a digital image of connector component of the drip line connection unit of FIG. 12, illustrating that the outlet of the tortuous path is through the screw thread connector.

FIG. 15 is a digital image illustrating the water measurement unit with the lid removed to show the side of the unit.

FIG. 16 is a digital image illustrating an alternative embodiment of the water measurement unit with the lid removed to show the side of the unit.

FIG. 17 is a digital image of the lid of the water measurement unit.

FIG. 18 is a digital image illustrating the two wires or leads that facilitate counting the water drops, and the air gap between the wires.

FIG. 19 is a circuit diagram illustrating one embodiment of the disclosed device.

### DETAILED DESCRIPTION

### I. Definitions

The following explanations of terms and methods are provided to better describe the present disclosure and to guide those of ordinary skill in the art in the practice of the present disclosure. The singular forms “a,” “an,” and “the” refer to one or more than one, unless the context clearly dictates otherwise. The term “or” refers to a single element of stated alternative elements or a combination of two or more elements, unless the context clearly indicates otherwise. As used herein, “comprises” means “includes.” Thus, “comprising A or B,” means “including A, B, or A and B,” without excluding additional elements. All references, including patents and patent applications cited herein, are incorporated by reference.

Unless otherwise indicated, all numbers expressing quantities of components, molecular weights, percentages, temperatures, times, and so forth, as used in the specification or claims are to be understood as being modified by the term “about.” Accordingly, unless otherwise indicated, implicitly or explicitly, the numerical parameters set forth are approximations that may depend on the desired properties sought and/or limits of detection under standard test conditions/methods. When directly and explicitly distinguishing embodiments from discussed prior art, the embodiment numbers are not approximations unless the word “about” is recited.

Unless explained otherwise, all technical and scientific terms used herein have the same meaning as commonly understood to one of ordinary skill in the art to which this disclosure belongs. Although methods and materials similar or equivalent to those described herein can be used in the practice or testing of the present disclosure, suitable methods and materials are described below. The materials, methods, and examples are illustrative only and not intended to be limiting.

### II. VRDI Emitter Design

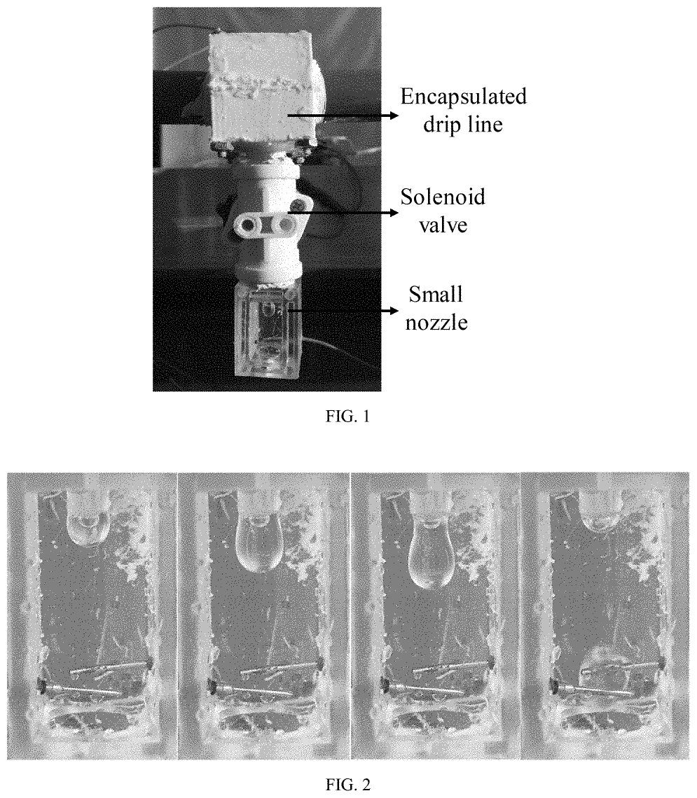

The disclosed VRDI device (FIG. 1) addresses the problem of actively monitoring and controlling water application at the point of delivery. The device comprises a drip line connection unit that connects the device to a drip line, a valve to regulate water flow, and a counting or measurement unit that produces and counts water drops.

A. Drip Line Connection Unit

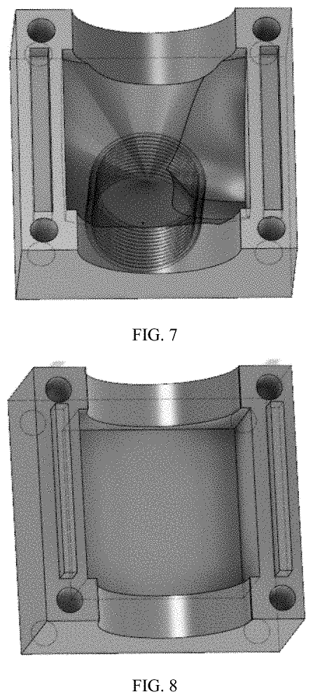

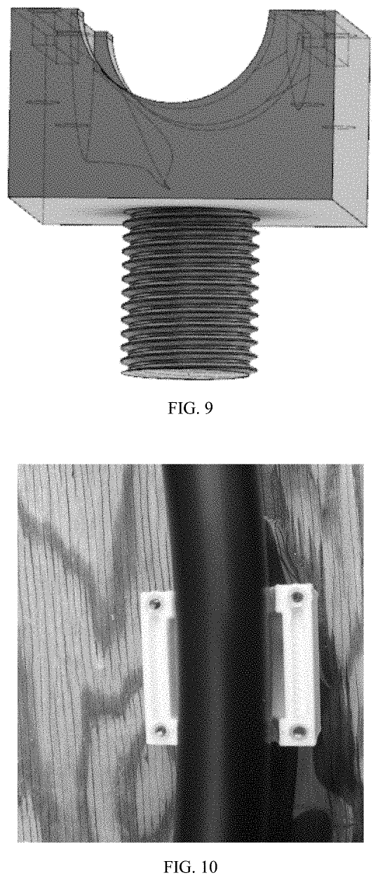

FIG. 6 illustrates how the drip line connection unit of the disclosed device attaches to the drip line. The drip line connection unit comprises two components, the connector component and the lid component, that can come apart to be placed around the drip line (FIGS. 7-10). The connector component includes a connector that attaches the drip line connection unit to a valve unit. The lid component and connector component together define a hole through the drip line connection unit through which a drip line can pass, thereby attaching the drip line connection unit to the drip line (FIG. 6). The hole is selected to be of a size sufficient to prevent the drip line connection unit from sliding along the drip line while at the same time not restricting water flow through the drip line.

The two components may be located on the drip line to envelop an existing perforation in the drip line (FIG. 11) or the drip line connection unit may penetrate the drip line to make a new perforation. In such embodiments, the drip line connection unit may comprise a sharp component, such as a needle or blade, that facilitates perforation of the drip line. The drip line connection unit may have a size suitable to connect to a drip line and receive water without substantial water leakage. Drip lines may have a diameter of from greater than zero to 25 mm or more, such as from 5 mm to 25 mm, from 10 mm to 25 mm, from 15 mm to 20 mm, or from 16 mm to 18 mm. Certain drip lines have a diameter of 17.8 mm. In certain disclosed embodiments, the drip line connection unit has a dimensions of 34×30×30 mm (L×W×H). The drip line connection unit also may comprise a connector suitable to fluidly connect the drip line connection unit to a valve that can control the water flow, such as an electronic solenoid valve. The connector may be a screw thread, such as a ½ inch×20 thread, and may have a length suitable to securely attach the drip line connection unit to the valve. In certain disclosed embodiments, the connector is a 15 mm screw thread. The connector also comprises a hole suitable to facilitate flow of the water from the drip line to the value, such as a hole of from greater than zero to 10 mm or more, or from 3 mm to 7 mm, and in some embodiments, the hole is a 5 mm diameter hole.

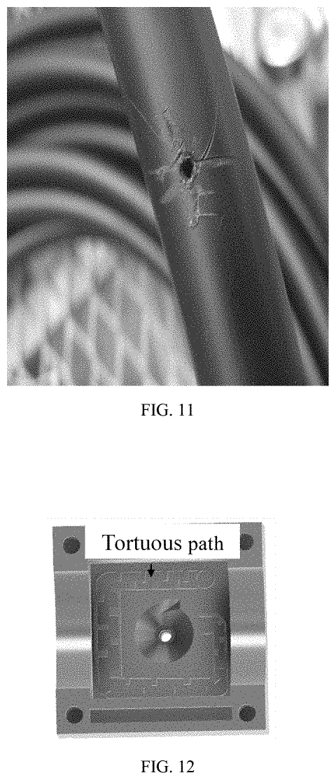

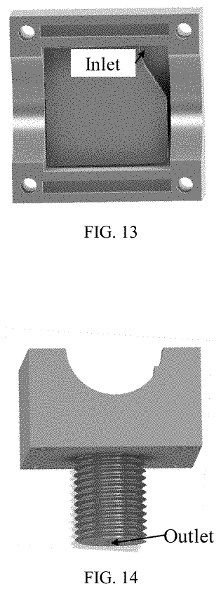

The drip line connection unit may further comprise a tortuous path that may reduce water pressure. FIGS. 12-14 illustrate an exemplary embodiment of an encapsulation compound comprising a tortuous path, and further illustrate the inlet and outlet of the tortuous path.

B. Water Measurement Unit

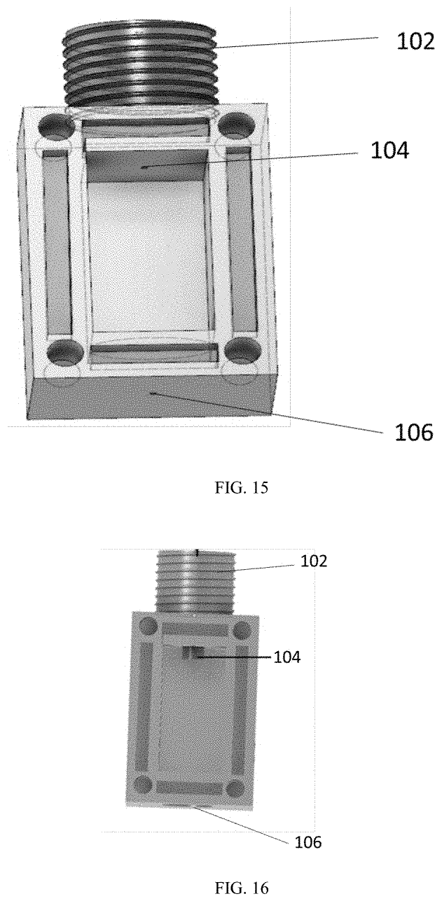

Embodiments of the disclosed device also comprise a water measurement unit. FIGS. 15 and 16 provides digital images of exemplary embodiments of the water measurement unit showing the inside of the unit, and FIG. 17 provides a digital image of the lid of the unit. With respect to FIGS. 15-17, the water measurement unit typically comprises a connector 102 that fluidly connects to the valve unit and comprises a water inlet to allow water to enter the measurement unit, a nozzle 104 that facilitates drop formation, and an outlet 106 to allow the drops to leave the unit. Nozzle 104 is designed such that it forms water drops of known and constant diameter. The outside diameter of the nozzle may be selected to produce water drops of a desired size and therefore volume. By varying the nozzle diameter, the device can be used for applications having varying water demands. High water demanding crops may need higher application rates (larger nozzles) whilst low water demand crops can be managed with lower flow rates and the smaller nozzles. The nozzle and/or nozzle housing may be replaced to provide a nozzle having a different diameter. The nozzle may have an outer diameter of from greater than zero to 5 mm or more, such as from 1 mm to 5 mm, from 2 mm to 4 mm, or from 3 mm to 3.5 mm. The final dimension of the created drops depends on this outer nozzle diameter as it is the last point of contact for the formed drops. Thus, the nozzle diameters can be customized to alter the drop sizes as needed. Typically, a smaller nozzle diameter produces smaller drops and a higher pressure may be required to drive those drops. In some embodiments, the nozzle diameter is selected such that the drops are larger and do not require high water pressure but the nozzle diameter isn't so large that surface tension gives way to a steady stream rather than discrete drops. In some embodiments, the internal diameter of nozzle 104 is from greater than zero to 5 mm, such as from 0.5 mm to 3 mm, from 1 mm to 2 mm, or from 1.1 mm to 1.15 mm. A person of ordinary skill in the art understands that the internal diameter of the nozzle also is less than the outer diameter of the nozzle. In some embodiments, the measurement unit has dimensions of 30×20×25 mm (L×W×H), and may have a screw thread connector, such as a ½ inch×20 screw thread, having a suitable length, such as from 10 mm to 15 mm, and in some embodiments, the screw thread has a length of 12 mm. In particular embodiments, the nozzle 104 has an outer diameter of 3 mm or 3.5 mm, and/or an inner diameter of 1.1 mm or 1.5 mm.

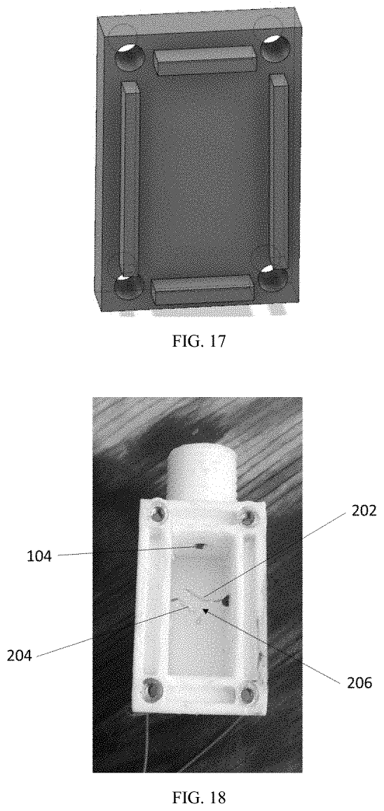

The measurement unit may also comprise two wires or leads 202 and 204 that facilitate counting the water drops (FIG. 18). The wires may be configured such that they are not in physical and/or electrical contact with each other and define an air gap 206 through which each water drop passes. The size of gap 206 is selected such that as the water drop passes through the gap the drop electrically connects the two wires, thereby completing an electric circuit and facilitating counting the drops (FIG. 2). The air gap may be from greater than zero to 10 mm or more, such as from greater than zero to 5 mm, or from 1 mm to 5 mm. In some embodiments, the minimum size of the air gap is sufficiently large to prevent a spark connection across the air gap, and the maximum size is sufficiently small such that the water drop completes the connection between the wires. Because each drop has a known volume, by specifying the number of drops applied, a precise amount of water can be applied by each device.

C. Water Control Valve

The device further comprises a water control valve that regulates water flow into the measurement unit. The valve can be any suitable valve that can facilitate or stop water flow. In some embodiments, the valve is a solenoid electric valve. The valve comprises two connectors that facilitate the valve fluidly connecting with the drip line connection unit and the water measurement unit. The valve may be shut, to stop water flow, or open, to allow water flow through the device. In some embodiments, the valve also may be partially open, thereby limiting the amount of water flowing through the device and/or acting as a pressure regulator between the drip line and the water measurement unit.

D. Control Unit

The disclosed device may further comprise a control unit that connects to the valve and the water measurement unit. The control unit receives an electrical signal whenever a water drop completes the electrical circuit between the two wires 202 and 204 in FIG. 18. As each drop passes between the leads the electric circuit keeps a running count of the number of times the circuit is closed which is equal to the number of water drops applied. The control value is actuated to cease the flow when the total volume (number of drops×water volume per drop) reaches the desired water application volume. The control unit re-opens when it receives the next irrigation instruction to execute. The signal may be from a timer, an environmental measurement, a computer, and/or a person.

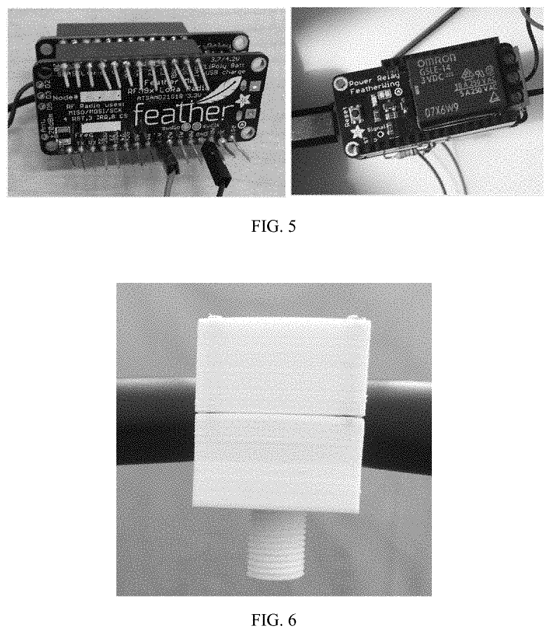

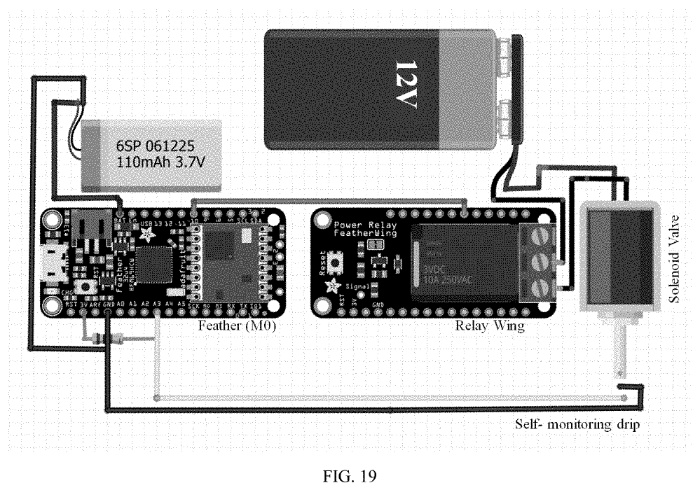

The control unit may comprise a control board and/or a relay, such as an Adafruit feather microcontroller board (M0) and relay (FIG. 5). An exemplary circuit diagram is presented in FIG. 19. With respect to FIG. 19, the measurement unit connects with feather (M0) relay and the valve, such as a solenoid electronic valve. The wire leads, that are used to count the number of drops passing through the system, are housed just downstream of nozzle 104 (FIG. 18). Water drops connect these electronic leads to make complete electric circuit (FIG. 19). The feather (M0) counts water drops number (number of circuit closures) and closes the valve depending on the received irrigation instruction.

A irrigation system using the disclosed devices can specify the number of water drops at each location, and can monitor each control unit to vary the amount of water applied as required, such as with variable weather conditions and/or as the plant grows. This ensures that each plant receives a sufficient amount of water while significantly reducing water waste due to over watering. Additionally, by reporting the number of drops applied at each location, the system enables a water manager to monitor the irrigation in real time. The water manager may be a person, or it can be a computer, such as in an electronic control system, or a sensor(s) that monitors components of the agricultural system.

### III. Example

A test of a VRDI prototype according to the present disclosure was performed. A pressure-regulated flow was provided both for a conventional, pressure-compensated drip line and an embodiment of the disclosed VRDI technology. Two versions of the VRDI design were tested to determine the potential for the nozzle design to affect drop size. The test was done for two inside diameters of approximately 1.1 mm and 1.15 mm with two outside diameters of 3 mm and 3.5 mm, respectively. All drip irrigation systems were operated for 10 minutes, 20 minutes, 30 minutes and 60 minutes. All tests were performed for a range of operating pressures: 13.79 kPa, 27.58 kPa, 41.37 kPa, 55.16 kPa, 68.95 kPa and 82.74 kPa. Pressure was monitored with a pressure regulator. An Adafruit Feather M0 Basic microcontroller was used to record the time and number of drops. Water exiting the VRDI systems and the convention drip line were collected in graduated cylinders to measure the total volume of water applied. A photograph of the VRDI system was provided in FIG. 1. A time series of the progression of a drop from formation to emission is presented in FIG. 2.

### Result and Discussion

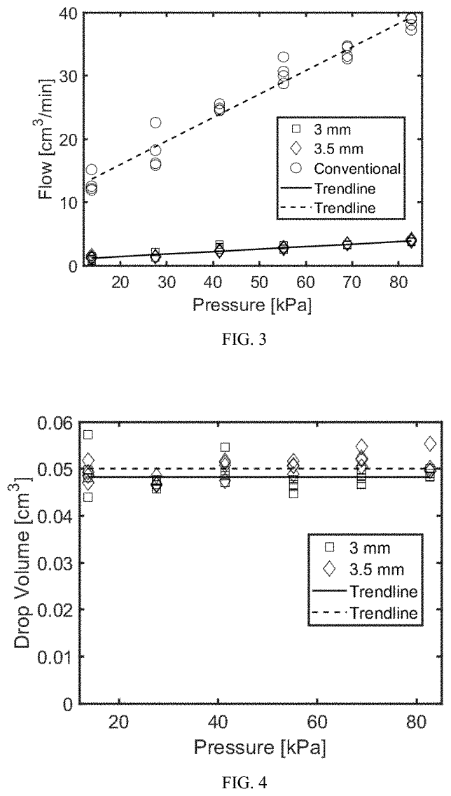

FIG. 3 provides the volumetric flow rates from each emitter as a function of operating pressure. The results show that both the new VRDI design and the conventional pressure compensated drip line had flow rates that depended on operational pressure. That is, the flow rates increased as the pressure increased. The VRDI design had lower flow rates generally (significant difference p<0.05), but these rates were not impacted by the changes in inner (1.1 mm, 1.15 mm) or outer (3 mm and 3.5 mm) nozzle diameter (p>0.05). Statistical significance determined via 2-tailes t-test. Without being bound to a particular theory, the lower flow rate in the VRDI may be due to the additional tortuous path through which the water flows inside the device.

FIG. 4 provides the volume of water per drop in the VRDI emitter as a function of operational pressure. FIG. 4 demonstrates that the drop size remained substantially constant for each nozzle irrespective of the pressure, and that the drop size increased as the outer diameter of the nozzle increased. The water volume per drop was significant different (p<0.05) between nozzle designs with 3.5 mm and 3 mm outside diameters. Statistical significance determined via 2-tailes t-test. The tests demonstrated that the disclosed VRDI system enabled precision control of irrigation water across a wide range of water pressures, and although the number of drops per minute increased as a function of pressure (FIG. 3), the volume of each drop remained constant. This means that if the total number of drops is controlled (rather than the drop rate), then the amount of water being delivered to any particular location can be precisely controlled, independent of water pressure.

### CONCLUSION

A new VRDI emitter prototype was designed, built, and tested. The tests revealed that similar to commercially available pressure compensated drip lines, the new VRDI emitter had flow rates that increased as the operational pressure increased. However, the new VRDI emitter was able to maintain a constant volume per drop for each drop emitted, irrespective of operational pressure. Thus by controlling the number of drops a precise amount of water can be delivered by each device, as opposed to current technology where the amount of water at each drip site or location varies with water pressure. This constant drop volume can be manipulated by altering the dimension of the outer nozzle diameter within the measurement chamber. Significant differences in the water volume per drop were found between designs that had outside diameters of 3.5 mm and 3 mm. The results demonstrated that a method for precise control of drip irrigation at the emitter level can be achieved by drop counting rather than monitoring flow rates. Without being bound to a particular theory, this may be due, at least in part, to capillary forces being substantially greater than inertial forces at this scale. This increase in relative forces can be exploited to create small-scale integrated flow volume sensors. The electronic components used to control the VRDI prototype emitter are readily compatible with off-the-shelf data telemetry solutions, thus each emitter can be controlled remotely and can send data back to a centralized data repository or decision maker, and a plurality of these emitters can be used to enable full field scale VRDI.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

We claim:

1. A device, comprising:
a drip line connection unit;
a valve fluidly connected to the drip line connection unit; and
a measurement unit comprising a nozzle configured to form water drops, the measurement unit being fluidly connected to the valve and configured to count the water drops formed by the nozzle.

2. The device of claim 1, wherein the drip line connection unit comprises a connector component and a lid component that together attach to an irrigation drip line, thereby fluidly connecting the drip line connection unit to the drip line.

3. The device of claim 1, wherein the drip line connection unit further comprises a blade or needle that perforates an irrigation drip line.

4. The device of claim 1, wherein the drip line connection unit further comprises a tortuous path.

5. The device of claim 1, wherein the nozzle has an inner diameter of from 0.5 mm to 3 mm.

6. The device of claim 1, wherein the nozzle has an outer diameter of from 1 mm to 5 mm.

7. The device of claim 6, wherein the nozzle has an outer diameter of from 3 mm to 3.5 mm.

8. The device of claim 1, wherein the measurement unit comprises two leads that define an air gap.

9. The device of claim 8, wherein the air gap is selected such that there is no physical or electrical contact between the two leads until a water drop falls into the air gap.

10. The device of claim 1, wherein the valve is an electrical solenoid valve.

11. The device of claim 1, further comprising a control unit.

12. The device of claim 11, wherein the control unit is configured to close the valve when the required number of water drops have passed through the measurement unit.

13. The device of claim 1, comprising:
a drip line connection unit comprising a tortuous path and a blade or needle that perforates an irrigation drip line;
an electronic solenoid valve fluidly connected to the drip line connection unit;
a measurement unit fluidly connected to the valve, the measurement unit comprising a nozzle having an outer diameter of from 3 mm to 3.5 mm, and two leads that together define a gap having a size sufficient that when a water drop formed by the nozzle passes through the gap the water drop forms an electrical contact between the two leads; and
a control unit electronically connected to the two leads and the electronic solenoid valve, the control unit configured to close the electronic solenoid valve when a desired number of drops have been counted.

14. A method, comprising:
providing the device of claim 1; and
using the device.

15. The method of claim 14, wherein using the device comprises setting a number of water drops to be applied.

16. The method of claim 14, wherein the method further comprises attaching the device to a drip line.
